(19) United States
(12) Patent Application Publication
(10) Pub. No.: US 2019/0369725 A1
(43) Pub. Date: Dec. 5, 2019

(54) GUIDED VIRTUAL REALITY SYSTEM FOR RELAXING BODY AND MIND

(71) Applicant: Awespire Technology Inc., Taipei City (TW)

(72) Inventors: YANG-SHENG CHEN, New Taipei City (TW); JUI-CHUN HSIAO, Taichung City (TW)

(21) Appl. No.: 16/425,984

(22) Filed: May 30, 2019

Related U.S. Application Data
(60) Provisional application No. 62/679,780, filed on Jun. 2, 2018.

(51) Int. Cl. G06F 3/01; G06F 3/16; G06T 19/00

(52) U.S. Cl. CPC G06F 3/015; G06F 3/165; G06F 2203/011; G06F 3/016; G06T 19/006; G06F 3/167

(57) ABSTRACT

Disclosed is a guided virtual reality system for relaxing body and mind, including a head-mounted display device, an audio play device, and a video processing device electrically connected the head-mounted display device and the audio play device. The guided virtual reality system employs a guiding voice and the corresponding virtual scene to guide a user to immerse into the virtual scene. The guiding voice actively changes the virtual scene for the user to deeply experience the sense of immersion, thereby greatly relaxing the body and mind of the user.

### CROSS-REFERENCE TO RELATED APPLICATION

This application claims priority of US provisional patent application No. 62/679,780, filed on Jun. 2, 2018, the content of which is incorporated herein in its entirety by reference.

### BACKGROUND OF THE INVENTION

### 1. Field of the Invention

The present invention generally relates to a guided virtual reality system, and more specifically to a guided virtual reality system for relaxing body and mind of the user by use of a guiding voice with a corresponding virtual scene, where the virtual scene varies with the content of the guiding voice, to enhance the sense of immersion.

2. The Prior Arts

Recently, virtual reality technology has become more mature, and been widely applied to various fields such as game console, product sale and promotion, science education, simulation training, and virtual touring. With the virtual world created by virtual reality technology, the user can freely experience different spaces at any time.

In general, the products created by virtual reality technology can be used at airports, shopping malls, department stores, hospitals, rehabilitation centers, companies, or factories. At the airport, tired passengers waiting for a flight or a flight transfer can use the virtual reality product to take a short time rest so as to recover from the tiredness for the next trip. Customers spending much time and getting exhausted at the shopping mall or department store can fast be refreshed for the next run of shopping by use the virtual reality product. The patient at the hospital, or rehabilitation center, takes a short period of leisure time through the virtual reality product to effectively relax body and mind and obtain comfort and tranquility so as to release mental pressure or uncomfortable feeling during therapy. At the company or factory, the virtual reality product helps the employee at a short time break like coffee break to acquire vigor for work, thereby increase the performance and efficiency.

As for deep rest and relaxing, some manufacturers have developed related virtual reality devices to provide a function of immersion experience. For example, a head-mounted product, Just Relax or VR Paradise sold by Mostly Human Studios provides three scenes at the beach including sunny afternoon, sunset, and moonlight night. At the same time, the sound of the ocean wave and sea birds played to make the user experience the beach scenery to relax body and mind. However, this product does not have guiding voice, and hence the effect of relaxation is limited.

Another virtual reality product, Lumen sold by Framestore VR Studio, primarily produces a sense of visual change in a direction from the user through interaction with the user and the virtual reality scene. In other words, the virtual scene can change with the user's action. While Lumen plays some guiding voice to direct the user at the beginning, these guiding voice and the virtual scenes are not directly and instantly related. As a result, the guiding effect is poorly weak.

Yet, although Guided Meditation VR and Guided Relaxation VR sold by Cubicle Ninjas provides various virtual scenes, background sounds, and guiding voices to make the user freely select any combination as desired, the virtual scenes do not change in accordance with the guiding voice. Thus, a sense of presence experienced by the user is greatly reduced, and the relaxing effect is negatively influenced.

Therefore, it is greatly needed to provide a new guided virtual reality system for relaxing body and mind, which employs specific guiding voice in collocation with a virtual scene, and the virtual reality scene is changed because of the guiding voice so as to increase the sense of immersion while experiencing the virtual scene, thereby overcoming the above problems in the prior arts.

### SUMMARY OF THE INVENTION

The primary object of the present invention is to provide a guided virtual reality system for relaxing body and mind, comprising a head-mounted display device, an audio play device, and an audio-video processing device for providing a guided virtual reality with a sense of immersion to the user, and specifically directing the user to effectively enjoy and experience a virtual reality scene, thereby relaxing body and mind. The audio-video processing device is connected to the head-mounted display device and the audio play device through a wire or wireless connection.

Specifically, the head-mounted display device is employed for Virtual Reality, Augmented Reality or Mixed Reality, and further receiving and playing an image of virtual scene corresponding to one of the many virtual scenes to provide an immersive visual feedback to the user.

The audio play device receives the audio data and provides the user an auditory feedback based on the received audio data. The auditory feedback comprises playing a virtual reality sound and a guiding voice corresponding to the virtual scene. Additionally, the audio-video processing device proceeds a control operation to generate and transmit the image of the virtual scene and the audio data to the head-mounted display device and the audio play device.

Further, the above control operation comprises a step of changing the virtual reality sound and the virtual reality scene image based on the guiding voice.

The present invention employs the guiding voice corresponding to the virtual scene, and the image of the virtual scene is changed in accordance with the guiding voice such that the sense of immersion can be enhanced and the effect of relaxing body and mind can be greatly improved.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing the guided virtual reality system for relaxing body and mind according to the embodiment of the present invention;

FIG. 2 is a view showing one illustrative example of the system according to the embodiment of the present invention; and

FIG. 3 is a view showing another illustrative example of the system according to the embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the scope of the present invention.

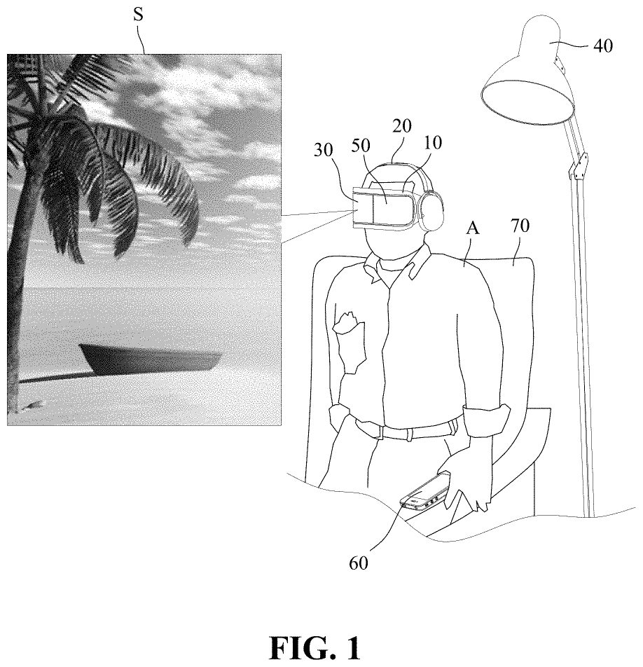

Please refer to FIG. 1 illustrating the guided virtual reality system for relaxing body and mind according to the embodiment of the present invention. As shown in FIG. 1, the guided virtual reality system of the present invention comprises a virtual reality head-mounted display (HMD) device 10, an audio play device 20, and an audio-video processing device 30 for providing a guided virtual reality with a sense of immersion to the user A, and specifically directing the user A to effectively enjoy and experience a virtual reality scene S, thereby relaxing body and mind. It should be noted that the left half of FIG. 1 shows the virtual reality scene S displayed by the head-mounted display device 10 and shown to the user A. In general, the head-mounted display device 10 is mounted on the head of the user A, and the audio play device 20 is provided close to the ear(s) of the user A.

Specifically, the head-mounted display device 10 is a Virtual Reality (VR), Augmented Reality (AR) or Mixed Reality (MR) device for receiving and playing a virtual reality scene image corresponding to one of virtual reality scenes to provide an immersive visual feedback to the user A. The virtual reality scene image is provided by the audio-video processing device 30.

The audio play device 20 receives the audio data and provides the user an auditory feedback based on the received audio data, and the auditory feedback comprises playing a virtual reality sound and a guiding voice corresponding to the virtual reality scene. The audio data is provided by the audio-video processing device 30. Preferably, the audio play device 20 comprises a speaker or earphone(s), especially a speaker with multiple sound tracks or a circumaural earphone. It should be noted that, the scope of the invention is not limited by the above illustrative example.

Further, the audio-video processing device 30 is connected to the head-mounted display device 10 and the audio play device 20 through a wire or wireless connection for proceeding a control operation to generate and output the virtual reality scene image and the audio data. The control operation comprises a step of changing the virtual reality sound and the virtual reality scene image based on the guiding voice.

Moreover, the guided virtual reality system of the present invention further comprises a sensory feedback device 40 such as a haptic lamp, which is electrically wired or connected to the audio-video processing device 30, and provides the user A a haptic feedback or an olfactory feedback based on the guiding voice under control of the audio-video processing device 30. For example, the haptic feedback comprises at least one of the heat radiation or the wind blow, and the olfactory feedback comprises at least one of the aroma transmitter or the fragrance mist spray.

The guided virtual reality system of the present invention further comprises a user state sensor 50, which is electrically connected to the audio-video processing device 30 for detecting a user state of the user A, and then generates and transmits a user state signal corresponding to the user state. The audio-video processing device 30 receives the user state signal. Additionally, the control operation further comprises another step of changing the virtual reality sound and the virtual reality scene image based on the user state, or changing the virtual reality sound, the virtual reality scene image, or the guiding voice based on the user state.

The above user state sensor 50 comprises at least one of an inertia measuring unit (IMU), an eye tracker, or an Electroencephalogram (EEG). Particularly, the IMU detects a pose orientation of the user A, the eye tracker detects a rotation of an eye ball of the user A, and the EEG detects and captures a brain wave of the user A. The audio-video processing device 30 receives and employs the pose orientation, the eye ball rotation, and the brain wave to estimate the user state.

Further, the system of the present invention further comprises a camera (not shown) for capturing and transmitting a user image of the user A to the audio-video processing device 30 to estimate the user state.

Additionally, the system of the present invention further comprises a user interface (not shown) for selecting the virtual reality scene or the guiding voice, and setting a background sound of the virtual reality scene, and an audio volume and tempo of the guiding voice for the user A. Preferably, the user interface comprises a select and set image frame generated and transmitted by the audio-video processing device 30, the head-mounted display device 10 receives and displays the select and set image frame, or a smart phone 60 connected to the audio-video processing device 30 receives and displays the select and set image frame.

Moreover, the control operation comprises a further step of changing the background sound of the virtual reality scene and the audio volume and tempo of the guiding voice based on the user state, and changing a brightness level, a position, and a shape of each object included in the virtual reality scene image to guide visual fixation and respiration tempo of the user A so as to implement a function of visual guide.

The audio-video processing device 30 can be configured to connect a cloud recording device (not shown), and automatically record and upload the user state and an operation history of the user A to the cloud recording device. The user state and the operation history are provided for the user or a medical care-taking person for reference, thereby implementing a cloud recording function.

More specifically, the system of the present invention comprises a posture detection module, which is electrically connected to the audio-video processing device 30 for detecting a stature and a posture of the user A, and generating and transmitting a stature information and a posture information to the audio-video processing device 30 for adjusting a view angle and a view position of the virtual reality scene with respect to the user A. With that, the user A can view and enjoy the virtual reality scene image at a preferred view angle and position, thereby reducing visual stress and avoiding visual fatigue.

For example, the user A can sit on the chair 70 to comfortably experience and enjoy the guided virtual reality provided by the present invention, or lie on a lounge chair (not shown) to fully relaxing body and mind, even entering a deeply sleep state.

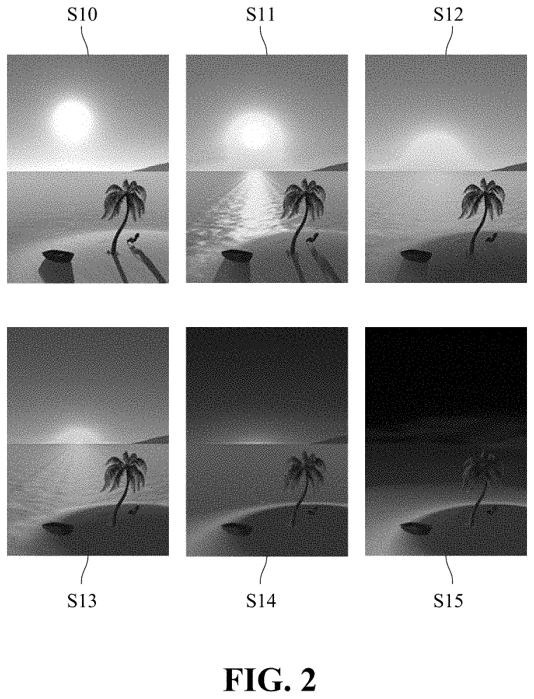

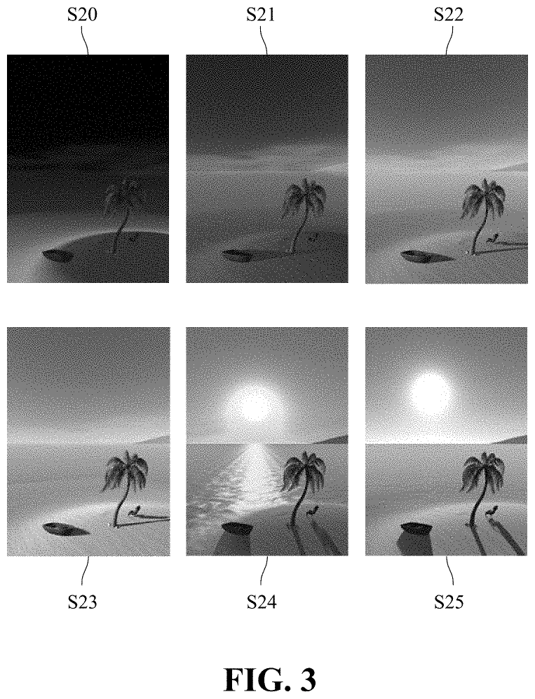

To more clearly describe the aspects of the present invention, please refer to FIG. 2 illustrating one illustrative example of the system according to the embodiment of the present invention. When the guiding voice is “the sun is falling down below the sea”, the audio-video processing device 30 controls the head-mounted display device 10 to sequentially display the virtual reality scenes S10-S15 to demonstrate a specific circumstance from the sunset to the night where the sun gradually falls down and finally below the sea in collocation with the sea water and the palm tree. In addition, FIG. 3 illustrates another illustrative example of the present invention. When the guiding voice is “the sun in the morning”, the head-mounted display device 10 sequentially displays the virtual reality scenes S20-S25 to show a scene where the sun gradually rises up from the sea level representing the transition from the night to the morning.

Therefore, with the virtual space created by the system of the present invention, the user may feel like living at an island in a lake surrounding with mountains to enjoy the warm sun, the breeze, and the pleasing scent in the fresh air. At the same time, the guided imagery for the user gradually adjusts the user's body and mind to approach a peaceful and harmonic state, and finally enter an extremely relaxed state in the night with twinkling stars.

The system of the present invention dynamically adjusts the system parameters based on the change of the virtual reality scene image or the user state to enhance the relaxing effect. For instance, when the guiding voice is “sea wind is blowing”, the sensory feedback device 40 like the haptic lamp starts to provide wind blow as the sensory feedback. If the guiding voice is “a whiff of fragrance”, the sensory feedback device 40 gives off flower scent as the olfactory feedback. Or, when the user state is a more relaxing state, the system of the present invention appropriately adjusts strength of the feedback to reduce interference with the user, avoiding any uncomfortable or negative effect.

From the above mention, one aspect of the present invention is that the guiding voice is employed to collocate with the virtual reality scene, and the virtual reality scene is dynamically changed with respect to the guiding voice so as to increase the sense of immersion during experiencing the virtual reality scene, thereby achieving the purpose of virtual reality relaxing and releasing pressure. At the same time, the virtual reality technology breaks through the barrier of space and time to make the user experience and enjoy a 360-degree immersive virtual scene in a short time like 10 minutes. Particularly, the user further gets rid of mundane worries with the help of the virtual reality scene like the sunrise, sunset, or twinkling-stars sky in collocation with the breeze in the fresh air.

Another aspect of the present invention is that the soft guiding voice and the pleasing sound like music make the user appropriately regulate tempo of respiration to focus on relaxing body and mind, thereby realizing the function of guided imagery.

Moreover, to enhance the effect of virtual reality immersion, the present invention employs the haptic feedback device like the heat radiation or the wind blow, and the olfactory feedback like giving off fragrance in addition to the visual feedback or the auditory feedback, and further uses various sensory feedbacks to correspond with variation of the sun, the moon, and the stars so as to provide the user the best virtual reality experience of relaxing body and mind.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A guided virtual reality system for relaxing body and mind, comprising:
a head-mounted display (HMD) device for Virtual Reality (VR), Augmented Reality (AR) or Mixed Reality (MR) and receiving and displaying an image of a virtual scene corresponding to one of many virtual scenes to provide a user an immersive visual feedback;
an audio play device for receiving an audio data and providing the user an auditory feedback based on the received audio data, the auditory feedback comprising playing a sound of the virtual scene and a guiding voice corresponding to the virtual scene; and
an audio-video processing device connected to the head-mounted display device and the audio play device through a wire or wireless connection for proceeding a control operation to generate and output the image and the audio data of the virtual scene, the control operation comprising changing the sound of the virtual scene or the image of the virtual scene according to the guiding voice.

2. The guided virtual reality system for relaxing body and mind as claimed in claim 1, further comprising a sensory feedback device electrically wired or connected to the audio-video processing device for providing the user a haptic feedback or an olfactory feedback corresponding to the guiding voice under control of the audio-video processing device, the haptic feedback comprises at least one of the heat radiation or the wind blow, and the olfactory feedback comprises at least one of the aroma transmitter or the fragrance mist spray.

3. The guided virtual reality system for relaxing body and mind as claimed in claim 1, further comprising a user state sensor electrically connected to the audio-video processing device for detecting a state of the user, and generating and transmitting a user state signal corresponding to the user state, the audio-video processing device receiving the user state signal, the control operation further comprising changing the sound of the virtual scene or the image of the virtual scene or the guiding voice.

4. The guided virtual reality system for relaxing body and mind as claimed in claim 3, wherein the user state sensor comprises at least one of an inertia measuring unit (IMU), an eye tracker, or an Electroencephalogram (EEG), the IMU detects a pose orientation of the user, the eye tracker detects a rotation of an eye ball of the user, the EEG detects and captures a brain wave of the user, and the audio-video processing device receives and employs the pose orientation, the rotation of the eye ball, or the brain wave to estimate the user state.

5. The guided virtual reality system for relaxing body and mind as claimed in claim 3, further comprising a camera for capturing and transmitting an image of the user to the audio-video processing device to estimate the user state.

6. The guided virtual reality system for relaxing body and mind as claimed in claim 1, further comprising a user interface for selecting one of the virtual scenes or the guiding voices, and setting a background sound of the virtual scene, or an audio volume or tempo of the guiding voice for the user.

7. The guided virtual reality system for relaxing body and mind as claimed in claim 6, wherein the user interface comprises a select-and-set image frame generated and transmitted by the audio-video processing device, and the select-and-set image frame received and displayed by the head-mounted display device, or by a mobile phone connected to the audio-video processing device, which generates and displays the select-and-set image frame.

8. The guided virtual reality system for relaxing body and mind as claimed in claim 3, wherein the control operation comprises changing the sound of the virtual scene or the audio volume or tempo of the guiding voice based on the user state, and further changing a brightness level, a position, and a shape of each object in the virtual scene to guide the eye fixation or the respiration tempo of the user to enhance the function of guided imagery.

9. The guided virtual reality system for relaxing body and mind as claimed in claim 3, wherein the audio-video processing device is connected to a cloud recording device, and automatically records and uploads the user state or an operation history of the user to the cloud recording device, and the user state or the operation history is provided to the user or a medical care-taking person for reference, thereby realizing a cloud recording function.

10. The guided virtual reality system for relaxing body and mind as claimed in claim 1, further comprising a posture detection module electrically connected to the audio-video processing device for detecting a stature or a posture of the user, and generating and transmitting a stature information or a posture information to the audio-video processing device for adjusting a viewing angle and a viewing position of the virtual scene with respect to the user.
